(19) United States
(12) Patent Application Publication
(10) Pub. No.: US 2026/0305642 A1
(43) Pub. Date: Oct. 8, 2026

(54) FRYING OIL

(71) Applicant: CARGILL, INCORPORATED, Wayzata, MN (US)

(72) Inventors: Junyin CHEN, Nantong (CN); Zhukun MA, Shanghai (CN); Weilin XUE, Nantong (CN); Zhenyu ZHAO, Dongguan (CN)

(21) Appl. No.: 18/998,296

(22) PCT Filed: Jul. 14, 2023
(86) PCT No.: PCT/CN2023/107494

§ 371 Date: Jan. 24, 2025

(30) Foreign Application Priority Data
Jul. 27, 2022 (WO) PCT/CN2022/108283

(51) Int. Cl. A23D 9/013; A23D 9/04; A23L 5/10

(52) U.S. Cl. CPC A23D 9/013; A23D 9/04; A23L 5/11

(57) ABSTRACT

A fat composition comprising a frying oil and 0.001%-1.0% of one or more polyglycerol fatty acid esters, wherein the polyglycerol fatty acid esters have a degree of polymerization of 2-4 and an esterification degree of more than 80%, a method of frying food using said fat composition and use of polyglycerol fatty acid esters having an esterification degree of more than 80% in frying oil to improve crispness of food that has been fried in said frying oil.

### FIELD OF THE INVENTION

The present invention relates to a fat composition comprising a frying oil and one or more polyglycerol fatty acid esters and its use to improve crispiness.

### BACKGROUND OF THE INVENTION

Fried foods are enjoyed by people around the world. Frying is a cooking method in which food is placed in or submerged in hot oil. Often, the frying oil is used to cook many food items, heated for long periods of time, and subjected to several cycles of cooling and re-heating.

The frying oil is employed as heating medium for cooking foodstuffs on frying pans, frying pots, cooking plates, or the like, and also for keeping the cooked foodstuffs from the frying pans and the like.

At present, to improve the crispy taste of the food main rely on the food itself or powdered seasonings in the food service market.

There is still a need for a frying oil that can have a positive impact on the crispiness and preferably the maintenance of the crunchy texture for a longer period of time. The current invention provides for such a frying oil.

### SUMMARY OF THE INVENTION

The present invention relates to a fat composition comprising a frying oil and 0.001% to 1.0% of one or more polyglycerol fatty acid esters.

It relates to the use of polyglycerol fatty acid esters having an esterification degree of more than 80% in frying oil to improve crispiness of food that has been fried in said frying oil.

Furthermore, it relates to method of frying food comprising the following steps:
a. Heating fat composition comprising a frying oil and 0.001% to 1.0% of polyglycerol fatty acid esters to a temperature of from 170 to 220° C.
b. Bringing food in the heated fat composition and continue heating until the food is fried,
   Wherein the polyglycerol fatty acid esters have an esterification degree of more than 80% and the polyglycerol fatty acid esters have a degree of polymerization of 2 to 4.

### DESCRIPTION OF FIGURES

FIG. 1: Comparison of sensory characteristics of fried dough sticks-texture & taste for products 1, 2 and 3: Hardness: 2 #commercial product and 3 #RBD frying oil (contains polyglycerol fatty acid ester) (is soybean oil containing 0.01% polyglycerol fatty acid esters) have similar hardness and are lower than that of 1 #regular soybean oil.
Crispness: Compared with 1 #regular soybean oil and 2 #commercial product, 3 #RBD frying oil (contains polyglycerol fatty acid esters) (is soybean oil containing 0.01% polyglycerol fatty acid esters) has a significant improvement in crispness.

FIG. 2: Comparison of sensory characteristics of fried dough sticks-texture & taste for products 3 and 4:3 #RBD frying oil (contains polyglycerol fatty acid ester) (is soybean oil containing 0.01% polyglycerol fatty acid esters) and 4 #RBD soybean frying oil (contains high level (=1.00%) of polyglycerol fatty acid ester) are very close in crispness.
In terms of hardness, 4 #is significantly lower than 3 #, and 4 #RBD soybean frying oil (contains high level (=1%) of polyglycerol fatty acid ester) fried dough sticks is relatively crumbly and crisp.

FIG. 3: Comparison of sensory characteristics of pork slices-texture & taste: Hardness: The hardness of the three fried pork slices is relatively close;
Crispness: Compared with 1 #regular soybean oil, 2 #Commercial product and 3 #RBD frying oil (contains polyglycerol fatty acid ester) (is soybean oil containing 0.01% polyglycerol fatty acid esters) have a significant improvement in crispness.
Greasiness: 3 #RBD frying oil (contains polyglycerol fatty acid ester) ((is soybean oil containing 0.01% polyglycerol fatty acid esters) has a slightly lower greasiness compared to 1 #and 2 #.

FIG. 4: Comparison of sensory characteristics of pork slices-texture & taste. In terms of hardness and crispness, compared with 3 #RBD frying oil (contains polyglycerol fatty acid ester) (is soybean oil containing 0.01% polyglycerol fatty acid esters), 4 #RBD soybean frying oil (containing high level (1.00%) of polyglycerol fatty acid ester) has a significant improvement, 4 #is crispier, but the hardness is obviously reduced, the fried pork slices are crispier.

### DETAILED DESCRIPTION

The present invention relates to a fat composition comprising a frying oil and 0.001% to 1.0% of one or more polyglycerol fatty acid esters.

There are in essence no specific limitations with respect to the oil or fat employed in the frying oil. Oils and fats which are conventionally employed for frying foodstuffs can be employed.

The frying oil is a liquid oil or a fat such as corn oil, soybean oil, rapeseed oil, cottonseed oil, rice bran oil, safflower oil, high-oleic safflower oil, sunflower oil, high-oleic sunflower oil, sesame oil, olive oil, palm oil, or lard, singly or in combination of one or more of these oils or fats.

Preferably, the frying oil is selected from soybean oil, canola oil, cottonseed oil, corn oil or blends of two or more thereof. More preferably soybean oil is used or a combination containing soybean oil.

In one aspect of the invention the frying oil is a blend of soybean oil and palm olein or a blend of soybean oil and super palm olein having an iodine value ((IV>=60).

The polyglycerol fatty acid esters have an esterification degree of more than 80%. The degree of esterification means a ratio of number of esterified hydroxyl groups per the total hydroxyl groups (esterified and non-esterified) of the glycerol.

Furthermore, in another aspect of the invention, the polyglycerol fatty acid esters have a degree of polymerization of 2 to 4. The degree of polymerization, or DP, is the number of monomeric units (is glycerol moiety) in the polyglycerol fatty acid esters.

The polyglycerol fatty acid esters are further characterized in that the fatty acids of the polyglycerol fatty acid esters have a chain length of C16 to C18. At least 80 weight %, up to 100 weight % of the constitutional fatty acid moieties of the polyglycerol fatty acid ester are occupied by saturated fatty acid moieties.

In a preferred aspect of the invention, the polyglycerol fatty acid esters have a degree of polymerization of 2 to 4 with concrete examples of polyglycerol fatty acid esters comprising polyglycerol fatty acid esters having a polyglycerol moiety comprising diglycerol, triglycerol and tetraglycerol.

Preferably the polyglycerol fatty acid esters are used in an amount of from 0.001 to 0.5% or from 0.01 to 0.1%.

In particular, these amounts allow to positively impact the crispiness of the fried food.

The current invention further relates to the use of polyglycerol fatty acid esters having an esterification degree of more than 80% in frying oil to improve crispiness of food that has been fried in said frying oil.

It relates to the use in frying oil of polyglycerol fatty acid esters having a degree of polymerization of 2 to 4 to improve crispiness of food that has been fried in said frying oil.

It relates to the use in frying oil of polyglycerol fatty acid esters in an amount of 0.001% to 1.0% to improve crispiness of food that has been fried in said frying oil.

It relates to the use in frying oil of polyglycerol fatty acid esters used in an amount of from 0.001 to 0.5% or from 0.01 to 0.1% to improve crispiness of food that has been fried in said frying oil.

It further relates to the use wherein the frying oil is selected from soybean oil, canola oil, cottonseed oil, corn oil or blends of two or more thereof.

It further relates to the use wherein the frying oil is a blend of soybean oil and palm olein or a blend of soybean oil and super palm olein having an iodine value ((IV>=60).

The present invention further relates to a method of frying food comprising the following steps:
a. Heating fat composition comprising a frying oil and 0.001% to 1.0% of polyglycerol fatty acid esters to a temperature of from 170 to 220° C.
b. Bringing food in the heated fat composition and continue heating until the food is fried,
   Wherein the polyglycerol fatty acid esters have an esterification degree of more than 80% and the polyglycerol fatty acid esters have a degree of polymerization of 2 to 4.

The fat composition of the present invention can be heated to any temperature useful to fry food products in the fat composition. In some aspects, the fat composition is heated to a temperature of at least 160° C., or at least 170° C., or in a temperature range of from 170 to 220° C.

Any type of frying technique can be used to fry the food product in the fat composition. Frying can include, but is not limited to, cooking techniques such as sauteing, stir-frying, pan frying, and deep frying. Sauteing refers to a cooking method in which a small quantity of oil is placed into a pan and the food is cooked on this oil. In sauteing, the oil does not come up the side of the food being cooked. Rather, the food is cooked on a thin layer of oil. Stir-frying refers to a cooking technique where oil is placed in a pan and the food product is cooked relatively quickly over high heat. The temperatures used in stir-frying are typically greater than that of sauteing. Additionally, in stir-frying, the food is consistently stirred and cooked more rapidly than in sauteing. Pan frying refers to a cooking method in which food is partially immersed in hot oil and cooked. In pan frying, the food product can be ⅓ to ½ submerged in the hot oil and cooked. Deep frying refers to a cooking technique where food is cooked by fully immersing the food in hot oil. In some aspects, the frying technique used in the present invention is pan frying or deep frying. In other aspects, the frying technique used in the present invention is deep frying.

Furthermore, the person skilled in the art is aware that foods of different shape and size, will require different frying times.

In the method of the present invention, the food is selected from meat, fish, and vegetables. In a specific aspect of the invention the food is selected from dough sticks, fish sticks, spring onion pancakes, chicken nuggets, French fries.

By using the fat composition of the present invention a significant improvement in crispness is observed for the food that was fried in the fat composition. By using the polyglycerol fatty acid esters in an amount of from 0.5% to 5.0 beyond the improved crispiness, a further improvement is noticed in view of reduced hardness of the fried food. In particular fried dough sticks and pork slices are more crumbly and crispy.

### EXAMPLES

The fat compositions of the present invention were compared in a frying cycle of 3 days with commercially available soybean oils.
Samples 1 #=regular soybean oil
Sample 2 #=commercial product.
Sample 3 #=soybean oil and 0.01% of polyglycerol fatty acid esters, and wherein the polyglycerol fatty acid esters have a degree of polymerization of 2 to 4
Sample 4 #=soybean oil and 1% of polyglycerol fatty acid esters, and wherein the polyglycerol fatty acid esters have a degree of polymerization of 2 to 4.

The food fried on the 3rd day was selected for the parallel comparison test.

The products to be fried were:
Deep fried dough stick
pork slice

### Frying Conditions:

Dough stick 183° C. (360° F.)/3.5 minutes

Put the same number of fried dough sticks into 4 oil vats, fry at 183° C./3.5 minutes, and compare the appearance & taste of the fried dough sticks from the 4 oil samples.
Pork Slice 171° C. (340° F.)/3.5 minutes

Put the same amount of pork slice into 4 oil vats, fry at 171° C./3.5 minutes, and compare the appearance & taste of the pork slices fried in the 4 oil samples.

### Sensory Methodology

A sensory evaluation Group composed of 10 persons who have completed the training and qualified for the evaluation in Cargill lab for 1-8 years.

### QDA (Quantitative Descriptive Analysis)

### Attributes Generation

Identify the attributes in products and confirm on the definitions
Qualitative discussion technique

### Score Attributes

Score attributes of each product based on the differences of products
0-15 scale used in this study

### Monitoring Performance

Monitor panel performance on Discrimination, Repeatability and Agreement to guarantee the data quality

### Data Collection

The order is randomized
Products are offered in sequence
At least 3 replications

### Key Descriptors and Evaluation Methods-Fried Dough Stick

| Evaluation Method | Description | Definition |
|---|---|---|
| The sample is placed in a | Appearance - | Used to describe the shade |
| disposable white tray and | Color | of color of the sample. |
| the appearance of the | | |
| sample is observed. | | |
| Take a bite of the sample | Taste - | Used to describe the amount |
| with the front teeth, then | Hardness | of force required to bite off a |
| transfer to the back teeth | | sample. |
| for chewing to evaluate the | Taste - | Used to describe the |
| texture and mouthfeel | Crispness | loudness of the sound when |
| characteristics of the | | the sample breaks. |
| product. | Taste - | Used to describe the force |
| | Toughness | and number of chews |
| | | required to bite and chew |
| | | the fried dough stick. |
| | Taste - | It is used to describe the |
| | Chewiness | for a sample to be chewed |
| | | from being placed in the |
| | | mouth until the sample can |
| | | be swallowed. |
| | Taste - | Used to describe how |
| | Greasiness | greasy the sample is |
| | | perceived in the mouth. |
| | Taste - | Used to describe the |
| | Stickiness | amount* of sample that |
| | | sticks to the teeth after |
| | | chewing. |
| | Taste - | It is used to describe the |
| | Dryness | degree of dryness of the |
| | | sample in the oral cavity. |
| | | The drier, the higher the |
| | | score. |

The amount* = Panellist's feeling on the amount of the sample that sticks to the teeth after chewing, normally scored from 0-15 scale

The obtained results are shown in FIGS. 1 and 2.

Key Descriptors and Evaluation Methods-Fried Pork Slice, coating of the product.

| Evaluation Method | Description | Definition |
|---|---|---|
| The sample is placed in a | Appearance - | Used to describe the shade |
| disposable white tray and | Color | of color of the sample. |
| the appearance of the | | |
| sample is observed. | | |
| Take a bite of the sample | Taste - | Used to describe the amount |
| with the front teeth, then | Hardness | of force required to bite off a |
| transfer to the back teeth | | sample. |
| for chewing to evaluate the | Taste - | Used to describe the |
| texture and mouthfeel | Crispness | oudness of the sound when |
| characteristics of the | | the sample breaks. |
| product. | Taste - | Used to describe the force |
| | Toughness | and number of chews |
| | | required to bite and chew |
| | | the fried dough stick. |
| | Taste - | It is used to describe the |
| | Chewiness | number of chews required |
| | | for a sample to be chewed |
| | | from being placed in the |
| | | mouth until the sample can |
| | | be swallowed. |
| | Taste - | Used to describe how |
| | Greasiness | greasy the sample is |
| | | perceived in the mouth. |

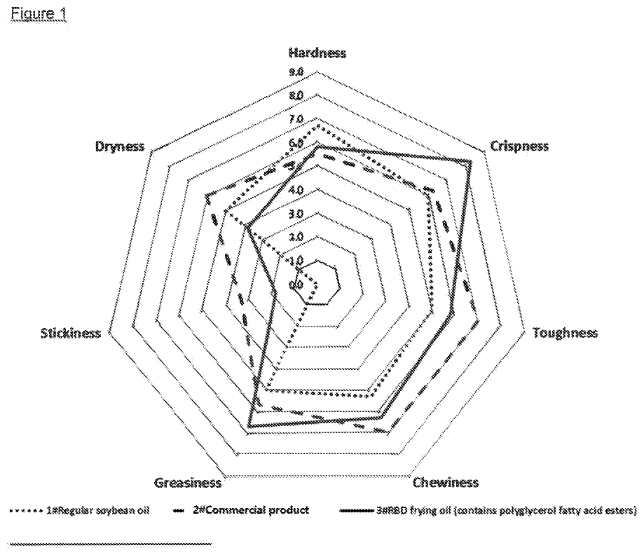

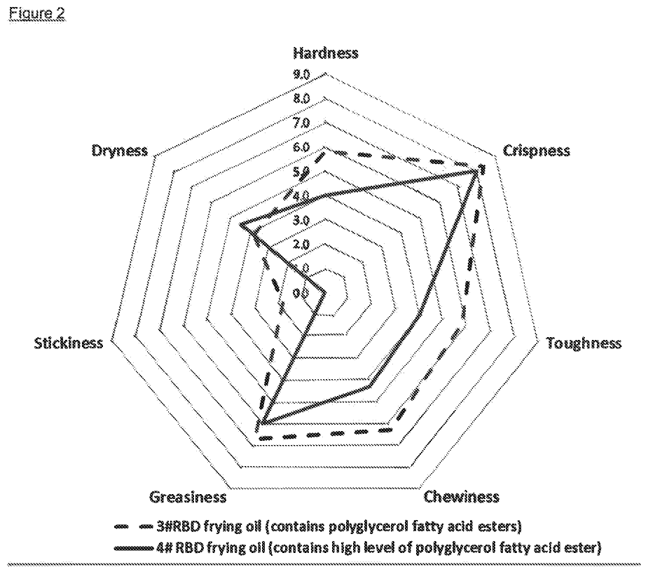

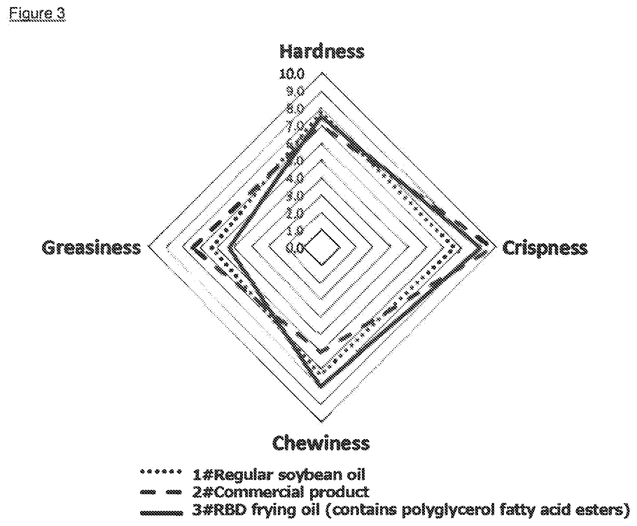

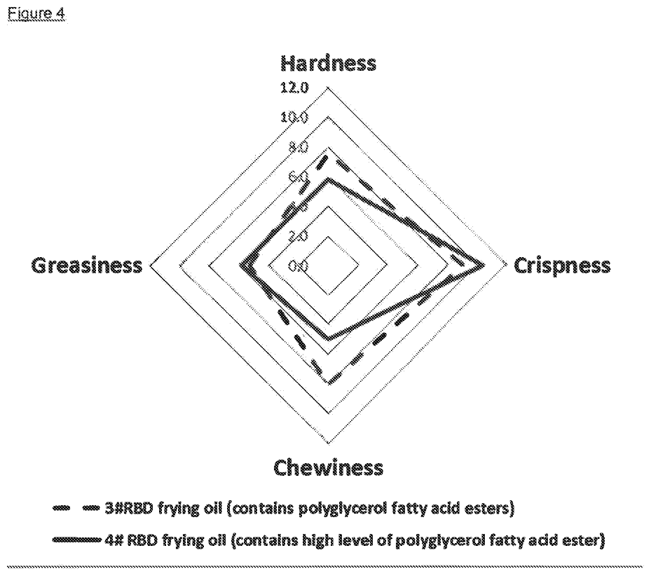

The obtained results are shown in FIGS. 3 and 4.

Texture Analyzer Data Comparison with soybean oil.

| | | | | Sample 4#: RBD |
|---|---|---|---|---|
| | | Com- | Sample 3#: RBD | Frying Oil |
| | | mercial | Frying Oil | (high level of |
| Day-3 | Regular | product | (polyglycerol | polyglycerol |
| Hardness | soybean | (for | fatty acid | fatty acid |
| g/Force | oil | frying) | ester 0.01%) | ester 1.0%) |
| Pork Slice | 5079.1 | 4359.4 | 4108.5 | 3061.8 |
| Deep fried | 390.9 | 459.9 | 396.2 | 135.7 |
| Dough Stick | | | | |

The higher the hardness, the lower the crispness.

1. A fat composition comprising a frying oil and 0.001% to 1.0% of one or more polyglycerol fatty acid esters.

2. The fat composition according to claim 1 wherein the polyglycerol fatty acid esters have an esterification degree of more than 80%.

3. The fat composition according to claim 1 wherein the polyglycerol fatty acid esters have a degree of polymerization of 2 to 4.

4. The fat composition according to claim 1 wherein the fatty acids of the polyglycerol fatty acid esters have a chain length of C16 to C18.

5. The fat composition according to claim 1 wherein the amount of polyglycerol fatty acid esters ranges from 0.001% to 0.5%.

6. The fat composition according to claim 1 wherein the amount of polyglycerol fatty acid esters ranges from 0.01% to 0.1%.

7. The fat composition according to claim 1 wherein the frying oil is selected from soybean oil, canola oil, cottonseed oil, corn oil or blends of two or more thereof.

8. The fat composition according to claim 1 wherein the frying oil is a blend of soybean oil and palm olein or a blend of soybean oil and super palm olein having an iodine value ((IV>=60).

9. Use of polyglycerol fatty acid esters having an esterification degree of more than 80% in frying oil to improve crispiness of food that has been fried in said frying oil.

10. A method of frying food comprising the following steps:
a. Heating fat composition comprising a frying oil and 0.001% to 1.0% of polyglycerol fatty acid esters to a temperature of from 170 to 220° C.
b. Bringing food in the heated fat composition and continue heating until the food is fried,
wherein the polyglycerol fatty acid esters have an esterification degree of more than 80% and the polyglycerol fatty acid esters have a degree of polymerization of 2 to 4.

11. The method of claim 10 wherein the food is selected from dough sticks, spring onion pancakes, chicken nuggets, French fries.
